(19) United States
(12) Patent Application Publication
(10) Pub. No.: US 2015/0024626 A1
(43) Pub. Date: Jan. 22, 2015

(54) CRIMPING STRUCTURE OF CABLE CONNECTOR

(71) Applicant: Yueh-Chiung Lu, Tao Yuan Hsien (TW)

(72) Inventor: Yueh-Chiung Lu, Tao Yuan Hsien (TW)

(21) Appl. No.: 14/270,479

(22) Filed: May 6, 2014

(30) Foreign Application Priority Data
Jul. 19, 2013 (TW) 102213751

(51) Int. Cl. H01R 4/20

(52) U.S. Cl. CPC H01R 4/20
USPC 439/578

(57) ABSTRACT

A crimping structure includes a plastic ring, an internal hollow pillar, a circular nut and an outer collar, and an embedding slot is formed around the external periphery of an end of the plastic ring for installing the circular nut, and an elastic crimping portion is disposed on a protruding end surface predetermined length of the end having the embedding slot, and at least one tapered groove is formed around the external periphery of the other end having the embedding slot. When the elastic crimping portion is elastically contracted, a waterproof function is achieved at the junction between the circular nut and the internal hollow pillar. With the tapered groove, at least one crimping assembly is formed, so as to provide a more secured connection between an electric cable and a cable connector and a more reliable and stable signal transmission.

### FIELD OF THE INVENTION

The present invention relates to a crimping structure of a cable connector, in particular to a stable and reliable crimping structure that provides a good waterproof performance, a highly secured connection with an electric cable.

### BACKGROUND OF THE INVENTION

Most coaxial cables (generally called electric cables) are connected to an engaging element (such as a F connector) of an electronic product by a rotary type cable connector. Basically, a conventional cable connector of this sort comprises a cable connecting body for fixing an electric cable and a circular nut having an inner thread, wherein the cable connecting body is formed by connecting and sheathing an outer collar, a circular body and an inner circular pillar with one another.

The circular nut is connected and partially sheathed on the outer circumferential surface of the circular body and the inner circular pillar through an end of the inner circular pillar. In the step of connecting a coaxial cable, the coaxial cable having an insulating coating removed from the front end of the coaxial cable in advance and a central conductor together with an insulating layer are extended to a predetermined length into the inner circular pillar, so that the central conductor is precisely protruded from the center of the circular nut, and the other end of the inner circular pillar is configured corresponsive to the circular nut and sheathed between the insulating layer of the coaxial cable and a mesh conductor.

The outer collar is abutted against the circular body from the other end opposite to the circular nut, so that the mesh conductor and the insulating coating disposed between the outer circumferential surface of the inner circular pillar and the outer collar provide a clamping and fixing effect, and the coaxial cable is situated at the mesh conductor between the circular body and the inner circular pillar and has an outwardly folded section of a predetermined length for forming a required grounding circuit.

In addition, some electronic products or signal distributors are installed outdoor. To prevent moisture from affecting the signal transmission quality, the conventional cable connector of this sort further includes an O-ring installed between the circular nut and the circular body, and a plastic inner sleeve installed between the outer collar and the electric cable for isolating and preventing water or moisture from entering into the connector. However, such arrangement requires more components in the overall cable connector, not just incurring a higher manufacturing cost, but requiring a more complicated and laborious manufacturing and assembling process.

Therefore, another conventional cable connector with a waterproof function was introduced into the market, and such cable connector comprises a circular body made of plastic, wherein the front end of the circular body is protruded from a position between the circular nut and the inner circular pillar, such that when the circular nut and the engaging element are engaged and coupled to each other, an elastic deformation is used for providing a water resisting function similar to that of the O-ring. When the other end of the circular body opposite to the circular nut presses against the circular body from the outer collar, the outer collar and the inner circular pillar produce a corresponding suppression force to produce a crimping effect at the force exerting position and in a direction towards the electric cable.

However, the crimping effect will not be increased with the level of pressing the outer collar towards the circular body, but it will be displaced with the outer collar to change the crimping position, and thus having no significant improvement on the fixing effect of the electric cable and the water resisting effect of the cable connector. Therefore, the electric cable inside the connector still may be shaken by strong wind and/or external force, and the signal transmission quality may be affected adversely.

### SUMMARY OF THE INVENTION

In view of the aforementioned drawbacks of the prior art, it is a primary objective of the present invention to provide a stable and reliable cable connector with a better waterproof performance and a better fixing effect of the electric cable.

To achieve the aforementioned objective, the present invention provides a crimping structure of a cable connector, and the crimping structure comprises a plastic ring, an internal hollow pillar, a circular nut, and an outer collar, wherein

The plastic ring has a cable passing section disposed therein, an embedding slot formed around the external periphery of an end of the plastic ring for installing a circular nut, and an elastic crimping portion having a predetermined length disposed on a protruding end surface at an end having the embedding slot, and at least one tapered groove formed around the external periphery of the other end having the embedding slot. Wherein, the internal hollow pillar is provided to be installed at the cable passing section of the plastic ring and displaced in an axial direction with respect to the plastic ring, and the internal hollow pillar includes a through hole formed therein, and a section of the internal hollow pillar extending into the plastic ring has a plug portion, and a first clamping portion is protruded from the external periphery of the rear end of the plug portion, and an end surface at the other end of the internal hollow pillar opposite to the first clamping portion has an abutting portion for pressing the elastic crimping portion of the plastic ring; the circular nut is sheathed on an end of the plastic ring having the embedding slot and rotatable with respect to the plastic ring, and the circular nut includes an inner thread section disposed therein, and the circular nut has a flange disposed around the internal periphery of the other end opposite to the inner thread section and embedded into the corresponding embedding slot; and the outer collar is sheathed on the other end of the plastic ring opposite to the circular nut and displaced in an axial direction with respect to the plastic ring, and a second clamping section is protruded from an inner edge of the rear end of the outer collar.

With the aforementioned structural characteristics, the crimping structure of a cable connector according to the present invention provides a waterproof function at the junction of the circular nut and the internal hollow pillar through the elastic contraction effect of the elastic crimping portion. In the process of pressing the outer collar towards the plastic ring, the rear end of the plastic ring is pushed and squeezed in an axial direction from the tapered groove towards the interior of the plastic ring to form at least one crimping assembly through the effect of the tapered groove, so as to improve the overall waterproof performance of the cable connector and achieve a more stable and reliable signal transmission effect of the electric cable.

Specifically, the crimping structure of a cable connector of the present invention has the following advantages and effects:

1. The invention provides better waterproof performance to assure signal transmission quality more positively and reliably.

2. The invention provides a more secured and reliable fixing effect of the electric cable.

3. The invention requires less components of the overall crimping structure of a cable connector, and provides easier installation and application.

4. The overall crimping structure of a cable connector gives a better water resisting effect with by using less number of components, not just lowering the manufacturing cost, but also improving the product competitiveness.

### BRIEF DESCRIPTION OF THE DRAWINGS

FIG. 1 is a cross-sectional view of a using status of a crimping structure of a cable connector in accordance with the present invention;

FIG. 2 is a cross-sectional view of a crimping structure of a cable connector in accordance with the present invention;

FIG. 3 is a perspective view of a crimping structure of a cable connector in accordance with a first preferred embodiment of the present invention;

FIG. 4 is a perspective view of a crimping structure of a cable connector in accordance with a second preferred embodiment of the present invention;

FIG. 5 is a cross-sectional view of a crimping structure at an initial status of being installed to a cable connector in accordance with the present invention;

FIG. 6 is a cross-sectional view of a crimping structure during the process of being installed to a cable connector in accordance with the present invention; and

FIG. 7 is a partial blowup view of a crimping structure of a cable connector after an electric cable is installed in accordance with the present invention.

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

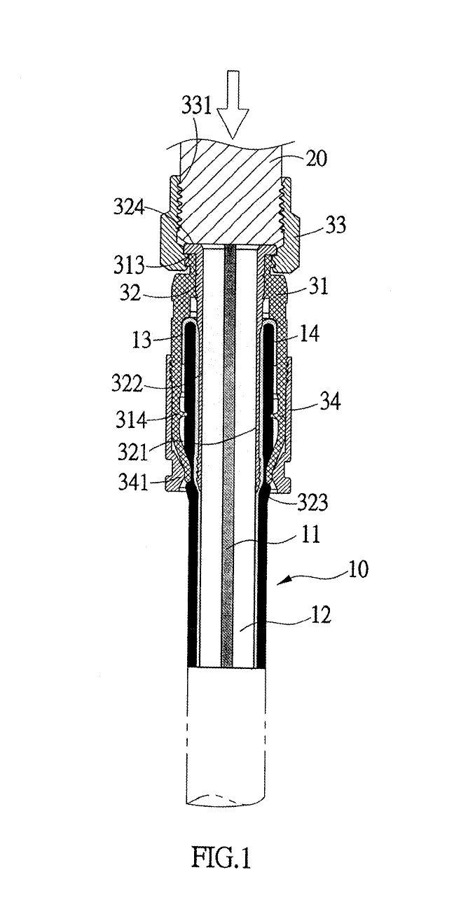

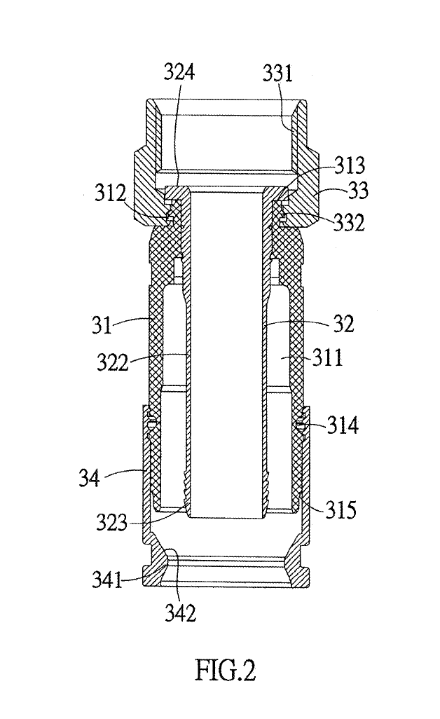

With reference to FIG. 1 for a cross-sectional view of a using status of a crimping structure of a cable connector in accordance with the present invention, the crimping structure is installed at a rear end of an electric cable 10 for connecting the electric cable 10 to an engaging element 20 quickly. With reference to FIG. 2, the crimping structure of a cable connector of the present invention comprises a plastic ring 31, an internal hollow pillar 32, a circular nut 33, and an outer collar 34.

The plastic ring 31 includes a cable passing section 311 disposed therein for accommodating the hollow pillar 32 and the electric cable 10, an embedding slot 312 formed around the external periphery of an end of the plastic ring 31 for installing the circular nut 33, an elastic crimping portion 313 having a protruding end surface with a predetermined length and formed at an end of the embedding slot 312, and at least one tapered groove 314 formed around the external periphery of the other end of the embedding slot 312.

The internal hollow pillar 32 is installed at the cable passing section 311 of the plastic ring 31 and displaced in an axial direction with respect to the plastic ring 31, and the internal hollow pillar 32 has a through hole 321 formed therein and provided for passing a central conductor 11 and an isolating layer 12 of the electric cable 10 to fix the central conductor 11 at the axial position of the crimping structure of a cable connector, and a section of the internal hollow pillar 32 extending into the plastic ring 31 has a plug portion 322 provided for plugging between an isolating layer 12 and a mesh conductor 13 of the electric cable 10, and a first clamping portion 323 is protruded from the external periphery of the rear end of the plug portion 322, and an abutting portion 324 is disposed on an end surface of the other end of the internal hollow pillar 32 opposite to the first clamping portion for pressing an elastic crimping portion 313 of the plastic ring 31 and contacting with the engaging element 20.

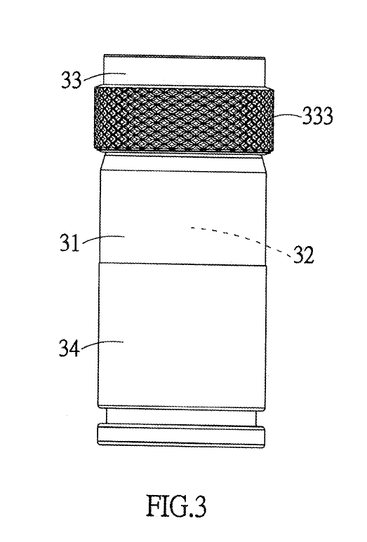

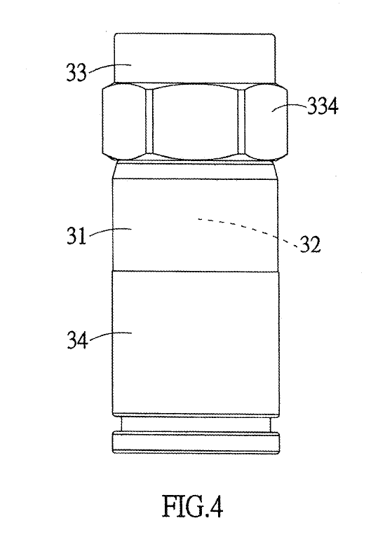

An end of the circular nut 33 with the plastic ring 31 being sheathed thereon has an embedding slot 312 and rotated with respect to the plastic ring 31, and the circular nut 33 has an inner thread section 331 formed therein and rotably coupled to the engaging element 20, and the circular nut 33 has a flange 332 disposed around an inner side of the other end of the inner thread section 331 for embedding the embedding slot 312. In an embodiment, a slippery resisting engraved line 333 is formed around the external periphery of the circular nut 33 as shown in FIG. 3, or plural mechanically clampable surfaces 334 are provided as shown in FIG. 4 for rotably coupling the engaging element 20 conveniently.

The outer collar 34 is sheathed on the other end of the plastic ring 31 opposite to the circular nut 33 and displaced in an axial direction with respect to the plastic ring 31, and a second clamping section 341 is protruded from an inner edge of the rear end of the outer collar 34.

Basically, when the crimping structure of a cable connector of the present invention is assembled, the circular nut 33 and the plastic ring 31 are embedded with each other, and then the plastic ring 31 is sheathed on the internal hollow pillar 32, and the outer collar 34 is sheathed on the other end of the plastic ring 31 opposite to the circular nut 33 to produce a product with the crimping structure of a cable connector comprised of a plastic ring 31, an internal hollow pillar 32, a circular nut 33 and an outer collar 34. In the product with the crimping structure of a cable connector, the circular nut 33 can be rotated with respect to the plastic ring 31, and the internal hollow pillar 32 and the outer collar 34 can be displaced in an axial direction with respect to the plastic ring 31. Therefore, the overall crimping structure of a cable connector can be simplified effectively to achieve the effects of lowering the manufacturing cost and providing easy installation and application.

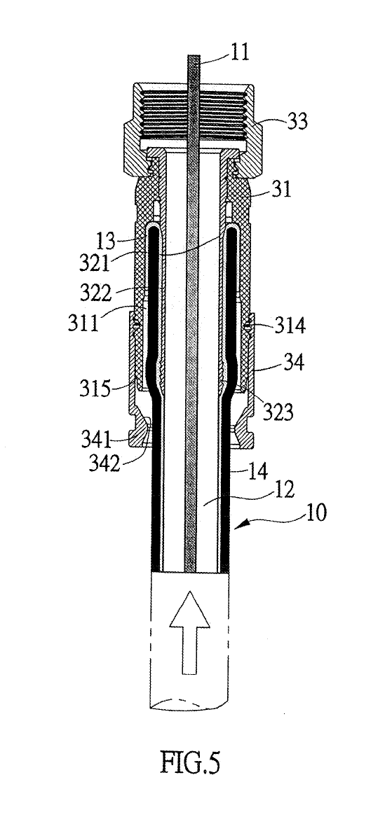

When the product with the crimping structure of a cable connector is installed and use as shown in FIG. 5, the outer collar 34 is maintained at a position away from the circular nut 33, so that a relatively larger passage is reserved at the other end of the plastic ring 31 opposite to the circular nut 33 to facilitate the electric cable to enter into the cable passing section 311, and the electric cable 10 with the insulating coating at the front end being peeled off and removed as well as the isolating layer 12 together with the central conductor 11 extending to a predetermined length are extended into the through hole 321 of the internal hollow pillar 32, and the plug portion 322 of the internal hollow pillar 32 is plugged between the isolating layer 12 and the mesh conductor 13 of the electric cable 10, and the electric cable 10 has a section with a predetermined length and folded outwardly from a position between the plug portion 322 and the cable passing section 311.

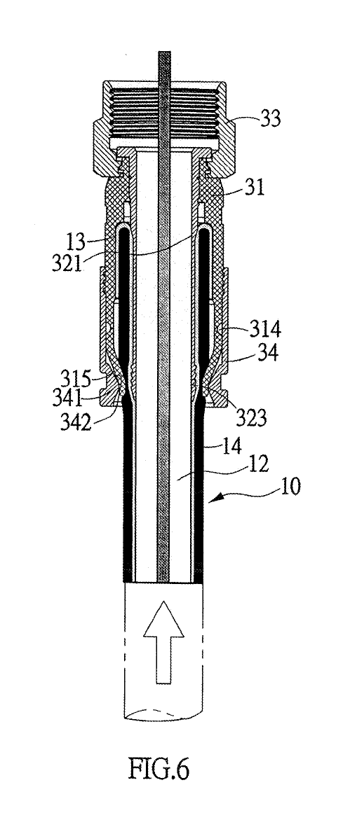

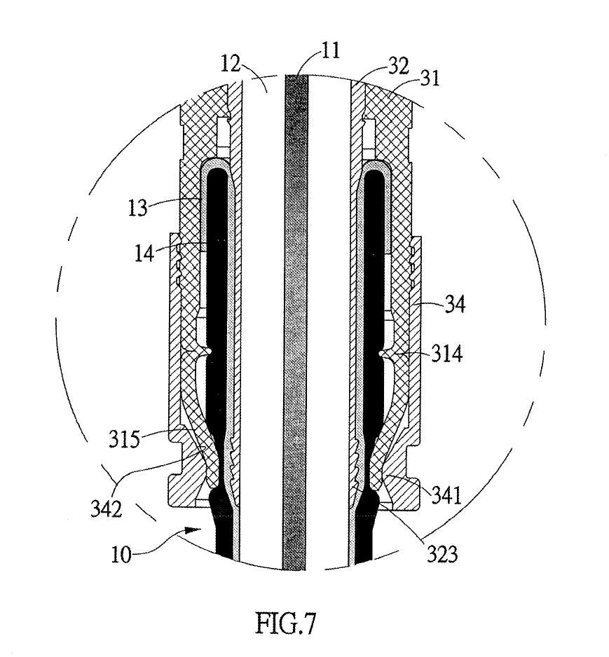

In the process of installing the electric cable 10 to the crimping structure of a cable connector, after the electric cable 10 is fixed to its position by means of the aforementioned methods, a pair of crimping pliers is used to press the outer collar 34 towards the plastic ring 31 as shown in FIG. 6 and FIG. 7. When the outer collar 34 is moved to the second stop slope 342 and contacted with the first stop slope 315 of the plastic ring 31, the first stop slope 315 of the plastic ring 31 faces the interior along an axial direction to press the insulating coating 14 of the electric cable 10 under the guidance of the second stop slope 342.

When the pair of crimping pliers continues pressing the outer collar 34 in a direction towards the plastic ring 31, the rear end of the plastic circular body 31 originally extended in an opposite direction out from the rear end of the outer collar 34 is retracted in a displacement direction of the outer collar 34 since the first stop slope 315 of the plastic circular body 31 presses against the insulating coating 14 of the electric cable 10 and is blocked by the first clamping portion 323 and the second stop slope 342, so that the plastic ring 31 at the position of the tapered groove 314 is deformed to push in an axial direction towards the interior of the plastic ring 31, and at least one crimping assembly is formed in the crimping structure of a cable connector, so as to improve the overall waterproof performance of the crimping structure of a cable connector and provide a stable and reliable fixing effect of the electric cable 10 and achieve the effects of preventing the electric cable from being shaken by strong wind and external forces effectively and maintaining a high signal transmission quality positively and reliably.

When the crimping structure of a cable connector connected with an electric cable 10 and the engaging element of an electronic product are connected and the circular nut 33 and the engaging element 20 are coupled securely as shown in FIG. 1, the internal hollow pillar 32 is pushed in a direction towards the interior of the plastic ring 31. Under the elastic contraction effect of the elastic crimping portion 313, a water resisting function is provided at the joint between the circular nut 33 and the internal hollow pillar 32 for isolating and preventing water or moisture from entering into the electric cable connector 30.

In a crimping structure of a cable connector of a preferred embodiment of the present invention as shown in FIG. 2, the plastic ring 31 has a first stop slope 315 with a tapered outer diameter and disposed at the rear end of the plastic ring 31, or the outer collar 34 has a second stop slope 342 disposed in the second clamping section 341 and having an inner diameter increasing towards the interior to improve the positioning effect of the rear end of the plastic ring 31 and clamp and fix the electric cable. Of course, the first stop slope 315 having a decreasing outer diameter and disposed at the rear end of the plastic ring 31 and the outer collar 34 having a second stop slope 342 disposed in the second clamping section 341 and having an increasing inner diameter towards the interior, so as to provide the best positioning effect at the rear end of the plastic ring 31 and clamp and fix the electric cable.

In addition, the internal hollow pillar 32 further has a lead angle disposed in the first clamping portion 323 and having an outer diameter decreasing towards the rear end, and the outer collar 34 further has a lead angle disposed in the second clamping section 341 and having an inner diameter increasing towards the rear end. Of course, the first clamping portion 323 of the internal hollow pillar 32 may have a lead angle with an outer diameter decreasing towards the rear end, and the outer collar 34 has a lead angle disposed in the second clamping section 341 with an inner diameter increasing towards the rear end, so as to facilitate the electric cable 10 to be plugged into a fixed position successfully.

Compared with the prior art, the crimping structure of a cable connector in accordance with the present invention has the following advantages and effects:

1. The invention provides better waterproof performance to assure signal transmission quality more positively and reliably.

2. The invention provides a more secured and reliable fixing effect of the electric cable.

3. The invention requires less components of the overall crimping structure of a cable connector, and provides easier installation and application.

4. The overall crimping structure of a cable connector gives a better water resisting effect with by using less number of components, not just lowering the manufacturing cost, but also improving the product competitiveness.

In summation of the description above, the present invention improves over the prior art, and is thus duly filed for patent application. While the invention has been described by means of specific embodiments, numerous modifications and variations could be made thereto by those skilled in the art without departing from the scope and spirit of the invention set forth in the claims.

What is claimed is:

1. A crimping structure of a cable connector, comprising:
a plastic ring, having a cable passing section disposed therein, an embedding slot formed around the external periphery of an end of the plastic ring for installing a circular nut, an elastic crimping portion with a predetermined length and disposed at an end of the embedding slot having a protruding end surface, and at least one tapered groove formed around the external periphery of the other end of the embedding slot;
an internal hollow pillar, installed in the cable passing section of the plastic ring and displaced in an axial direction with respect to the plastic ring, and the internal hollow pillar having a through hole formed therein, a plug portion disposed in a section of the internal hollow pillar extending into the plastic ring, a first clamping portion protruded from the external periphery of the rear end of the plug portion, and an abutting portion disposed on an end surface of the other end of the internal hollow pillar opposite to the first clamping portion and provided for pressing against the elastic crimping portion of the plastic ring;
a circular nut, sheathed on an end of the plastic ring having the embedding slot and rotated with respect to the plastic ring, and the circular nut having an inner thread section disposed therein, and the circular nut having a flange formed around the internal periphery of the other end of the inner thread section for embedding the corresponding embedding slot; and
an outer collar, sheathed on the other end of the plastic ring opposite to the circular nut and displaced in an axial direction with respect to the plastic ring, and the outer collar having a second clamping section protruded from the internal periphery of the rear end of the outer collar.

2. The crimping structure for cable connectors according to claim 1, wherein the plastic ring has a first stop slope having a tapered outer diameter and disposed at the rear end of the plastic ring.

3. The crimping structure for cable connectors according to claim 1, wherein the outer collar has a second stop slope with an inner diameter increasing towards the interior and disposed in the second clamping section.

4. The crimping structure for cable connectors according to claim 1, wherein the outer collar has a lead angle with an inner diameter increasing towards the rear end and disposed in the second clamping section.

5. The crimping structure for cable connectors according to claim 1, wherein the outer collar has a second stop slope having an inner diameter increasing towards the interior and disposed in the second clamping section and a lead angle having an inner diameter increasing towards the rear end.

6. The crimping structure for cable connectors according to claim 1, wherein the internal hollow pillar has a lead angle having an outer diameter decreasing towards the rear end and disposed in the second clamping section.

7. The crimping structure for cable connectors according to claim 1, wherein the circular nut has a slippery resisting engraved line formed at the external periphery of the circular nut.

8. The crimping structure for cable connectors according to claim 1, wherein the circular nut has a plurality of mechanically clampable surfaces disposed on the external periphery of the circular nut.
